(19) United States
(12) Patent Application Publication
(10) Pub. No.: US 2017/0234904 A1
(43) Pub. Date: Aug. 17, 2017

(54) SPEED SENSOR

(71) Applicant: Cotinental Teves AG & Co. oHG, Frankfurt (DE)

(72) Inventor: Frank Grunwald, Oberursel (DE)

(21) Appl. No.: 15/504,486

(22) PCT Filed: Sep. 22, 2015
(86) PCT No.: PCT/EP2015/071702

§ 371 Date: Feb. 16, 2017

(30) Foreign Application Priority Data
Sep. 22, 2014 (DE) 10 2014 219 011.8

(51) Int. Cl. G01P 3/46; G01D 5/20; G01P 3/52

(52) U.S. Cl. CPC G01P 3/465; G01P 3/52; G01D 5/204

(57) ABSTRACT

A speed sensor for detecting a speed of a magnetizable object. The speed sensor (100) can be supplied with an electric alternating signal with a first frequency by an electric signal source. The speed sensor including: a primary coil for generating a magnetic alternating field with the first frequency; first and second secondary coils. The first and second secondary coils can each be magnetically coupled to the primary coil via a magnetizable object. First and second electric signals induced in the first and second secondary coils respectively by the generated magnetic alternating field; a Goertzel filter bank detects first and second amplitude values of respective spectral components of the induced first and second electric signals in the event of a second frequency which differs from the first frequency. A processor determines the speed of the magnetizable object depending on the detected first amplitude value and the detected second amplitude value.

### CROSS REFERENCE TO RELATED APPLICATIONS

This application is the U.S. National Phase Application of PCT International Application No. PCT/EP2015/071702 filed Sep. 22, 2015, which claims priority to German Patent Application No. 10 2014 219 011.8, filed Sep. 22, 2014, the contents of such applications being incorporated by reference herein.

### FIELD OF THE INVENTION

The present invention relates to a speed sensor.

### BACKGROUND OF THE INVENTION

A motor vehicle often comprises a multiplicity of movable objects, the position of which is sensed by means of sensors. In order to sense the speed of a movable object, the position of the movable object is often repeatedly sensed with a subsequent difference and quotient calculation. However, it is necessary in this case to sense the position of the movable object at least twice and to carry out a complicated calculation in order to be able to determine the speed of the movable object. Furthermore, noise in the speed signal may be increased when continuously determining the speed in order to generate a speed signal on the basis of the formation of the difference.

### SUMMARY OF THE INVENTION

An aspect of the invention is to specify a more efficient speed sensor.

According to one aspect of the invention, a speed sensor for sensing a speed of a magnetizing object is provided. The speed sensor being able to be supplied with an electrical alternating signal at a first frequency by an electrical signal source, having: a primary coil for generating an alternating magnetic field at the first frequency; a first secondary coil and a second secondary coil, the first secondary coil and the second secondary coil each being able to be magnetically coupled to the primary coil by means of a magnetizable object, and a first electrical signal being able to be induced in the first secondary coil and a second electrical signal being able to be induced in the second secondary coil by the alternating magnetic field which is generated; a Goertzel filter bank for recording a first amplitude value of a spectral component of the induced first electrical signal and a second amplitude value of a spectral component of the induced second electrical signal at a second frequency which differs from the first frequency; and a processor for determining the speed of the magnetizing object on the basis of the recorded first amplitude value and the recorded second amplitude value. This achieves the advantage that the speed of the magnetizing object can be efficiently sensed.

The speed sensor according to an aspect of the invention can be integrated inside another sensor, for example a travel sensor, and may form part of it. Therefore, the term “speed sensor” should be understood as meaning a sensor which has the features according to the invention in order to sense the speed of a moving element on the basis of the available data. As described below, the speed sensor is also suitable for sensing the acceleration. For the sake of clarity, the term “speed sensor” is used.

The magnetizable object may comprise a soft-magnetic element or may be formed by a soft-magnetic element. The magnetizing object may also be an element of a movable piston.

The electrical signal source may be an AC voltage source or an alternating current source. The electrical signal source may also comprise a frequency generator, a resonant circuit and/or a voltage-controlled oscillator (VCO).

The first frequency may be predetermined or can be adjusted by means of an actuation element, such as a pushbutton, a rotary knob or a dual in-line package (DIP) switching element, of the electrical signal source. For example, the first frequency is 1 Hz, 10 Hz, 100 Hz, 1 kHz, 10 kHz, 100 kHz, 1 MHz, 10 MHz or 100 MHz. According to one embodiment, the second frequency may be twice the first frequency.

The primary coil and the respective secondary coils may form a differential transformer or may be included in a differential transformer. Furthermore, the primary coil and the respective secondary coils may be elements of a linear inductive position sensor (LIPS).

The Goertzel filter bank may also comprise a filter element, such as a Goertzel filter, for filtering the first electrical signal and/or the second electrical signal according to the Goertzel algorithm. Such a filter element can be used to sense an amplitude of the electrical signal at a predetermined frequency, such as the second frequency.

In one advantageous embodiment, the recorded respective amplitude value is a voltage value or a current value of the respective electrical signal. This achieves the advantage that the respective amplitude value can be efficiently recorded.

In another advantageous embodiment, the processor is designed to determine a difference between the recorded respective amplitude values in order to determine the speed of the magnetizing object. This achieves the advantage that a particularly cost-effective processor can be used on account of the simple mathematical operation.

In another advantageous embodiment, the processor is designed to determine a Fourier coefficient on the basis of the recorded respective amplitude values in order to determine the speed of the magnetizing object. This achieves the advantage that the speed of the magnetizing object can be determined in a particularly exact manner. For example, the Fourier coefficient is a second Fourier coefficient.

In another advantageous embodiment, the speed sensor is designed with a memory in which calibration data are prestored, the processor being designed to determine the speed of the magnetizing object on the basis of the recorded respective amplitude values and the calibration data. This achieves the advantage that the speed sensor can be adjusted.

In another advantageous embodiment, the calibration data are prestored in the memory in the form of a look-up table. This achieves the advantage that the processor can efficiently access the calibration data.

In another advantageous embodiment, the processor is also designed to determine a difference between the recorded respective amplitude values, and a difference between the recorded respective amplitude values is assigned to a speed of the magnetizing object in the look-up table. This achieves the advantage that the speed of the magnetizing object can be efficiently determined.

In another advantageous embodiment, an analog/digital converter is connected upstream of the Goertzel filter bank. This achieves the advantage that the Goertzel filter bank can be formed by a cost-effective microprocessor for digital signal processing.

In another advantageous embodiment, a window device for signal windowing is connected upstream of the Goertzel filter bank. This achieves the advantage that an accuracy of the sensing of the speed of the magnetizing object can be increased.

The window device may be designed to apply a window function to the first electrical signal and/or the second electrical signal. For example, the window function is a rectangular window function, a Hamming window function, a Hanning window function, a Von-Hann window function, a Blackman window function, a Bartlett window function, a cosine window function, a Tukey window function, a Lanczos window function, a Kaiser window function or a Gauss window function.

In another advantageous embodiment, the Goertzel filter bank comprises a further electrical signal source for generating a reference signal at the second frequency. This achieves the advantage that it is possible to dispense with an external electrical signal source for generating the reference signal at the second frequency.

In another advantageous embodiment, the second frequency is twice the first frequency, and the Goertzel filter bank comprises a frequency doubler for generating a reference signal at the second frequency. This achieves the advantage that the reference signal can be provided at the second frequency in a particularly cost-effective manner.

In another advantageous embodiment, the Goertzel filter bank comprises a first Goertzel filter for recording the first amplitude value and a second Goertzel filter for recording the second amplitude value. This achieves the advantage that the respective amplitude values can be efficiently recorded.

In another advantageous embodiment, the first frequency is in the range between 5 kHz and 20 kHz. This achieves the advantage that an accuracy of the sensing of the speed of the magnetizing object can be increased.

In another advantageous embodiment, the speed sensor is designed with a further Goertzel filter bank for recording a further amplitude value of a further spectral component of the induced first electrical signal and/or of the induced second electrical signal at the first frequency, the processor also being designed to determine a position of the magnetizing object on the basis of the recorded further amplitude value. This achieves the advantage that a position of the magnetizing object can be additionally sensed using the speed sensor.

In another advantageous embodiment, the speed sensor is designed with a further Goertzel filter bank for recording a further amplitude value of a further spectral component of the induced first electrical signal and/or of the induced second electrical signal at a third frequency which differs from the first frequency and from the second frequency, the processor also being designed to determine an acceleration of the magnetizing object on the basis of the recorded further amplitude value. This achieves the advantage that an acceleration of the magnetizing object can be additionally sensed using the speed sensor. According to one embodiment, the third frequency may be three times the first frequency.

An aspect of the invention also relates to a method for determining the speed or acceleration using a speed sensor according to one of the embodiments mentioned above, comprising the steps of:
determining the speed of the magnetizing object on the basis of the recorded first amplitude value and the recorded second amplitude value by means of the processor, and
determining a difference between the recorded respective amplitude values by means of the processor in order to determine the speed of the magnetizing object.

The method is advantageously developed, in particular, by virtue of the fact that the processor is used to determine a Fourier coefficient on the basis of the recorded respective amplitude values in order to determine the speed of the magnetizing object.

Further advantageous embodiments of the method according to the invention can be derived from the above-mentioned embodiments of the speed sensor.

### BRIEF DESCRIPTION OF THE DRAWINGS

Exemplary embodiments of the invention are illustrated in the drawing and are described in more detail below.

In the drawing:

FIG. 1 shows a schematic illustration of a speed sensor according to one embodiment.

### DETAILED DESCRIPTION OF THE PREFERRED EMBODIMENTS

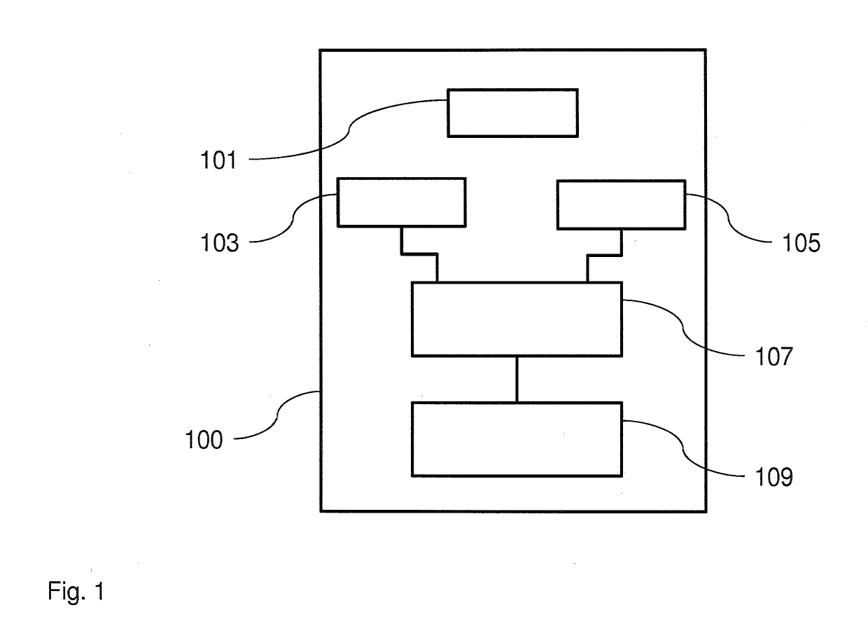

FIG. 1 shows a schematic illustration of a speed sensor 100 according to one embodiment. The speed sensor 100 comprises a primary coil 101, a first secondary coil 103, a second secondary coil 105, a Goertzel filter bank 107 and a processor 109.

The speed sensor 100 for sensing a speed of a magnetizing object, the speed sensor 100 being able to be supplied with an electrical alternating signal at a first frequency by an electrical signal source, can be designed with: the primary coil 101 for generating an alternating magnetic field at the first frequency; the first secondary coil 103 and the second secondary coil 105, the first secondary coil 103 and the second secondary coil 105 each being able to be magnetically coupled to the primary coil 101 by means of a magnetizable object, and a first electrical signal being able to be induced in the first secondary coil 103 and a second electrical signal being able to be induced in the second secondary coil 105 by the alternating magnetic field which is generated; the Goertzel filter bank 107 for recording a first amplitude value of a spectral component of the induced first electrical signal and a second amplitude value of a spectral component of the induced second electrical signal at a second frequency which differs from the first frequency; and the processor 109 for determining the speed of the magnetizing object on the basis of the recorded first amplitude value and the recorded second amplitude value.

The magnetizable object may comprise a soft-magnetic element or may be formed by a soft-magnetic element. The magnetizing object may also be an element of a movable piston.

The electrical signal source may be an AC voltage source or an alternating current source. The electrical signal source may also comprise a frequency generator, a resonant circuit and/or a voltage-controlled oscillator (VCO).

The first frequency may be predetermined or can be adjusted by means of an actuation element, such as a pushbutton, a rotary knob or a dual in-line package (DIP) switching element, of the electrical signal source. For example, the first frequency is 1 Hz, 10 Hz, 100 Hz, 1 kHz, 10 kHz, 100 kHz, 1 MHz, 10 MHz or 100 MHz. According to one embodiment, the second frequency can be twice the first frequency.

The primary coil 101 and the respective secondary coils 103, 105 may form a differential transformer or may be included in a differential transformer. The primary coil 101 and the respective secondary coils 103, 105 may also be elements of a linear inductive position sensor (LIPS).

The Goertzel filter bank 107 may also comprise a filter element, such as a Goertzel filter, for filtering the first electrical signal and/or the second electrical signal according to the Goertzel algorithm. Such a filter element can be used to sense an amplitude of the electrical signal at a predetermined frequency, such as the second frequency.

According to one advantageous embodiment, the speed sensor 100 or a linear inductive position sensor (LIPS) may comprise a differential transformer which is operated at a defined application frequency, such as the first frequency. The respective electrical signals induced or produced in this case in the respective secondary coils 103, 105, such as respective secondary voltages, can be evaluated in a frequency-selective manner. In this case, the frequency selectivity can be achieved using a Goertzel filter. For this purpose, the Goertzel filter uses a method based on a Fourier transform, but, in contrast to a Fourier transform, the amplitudes of the frequencies of an entire spectrum are not determined, but rather only the amplitude at one frequency, namely the excitation frequency, such as the first frequency. The difference between the respective secondary amplitudes, which is determined using this method, is a measure of the position of the magnetizing object, such as a magnet.

According to another advantageous embodiment, the speed sensor 100 can be operated at the first frequency, such as a frequency f, and the secondary voltages can be evaluated at the second frequency, such as twice the frequency. In this case, the second Fourier coefficient can be determined. This coefficient is proportional to the rate of change of the respective electrical signals and can therefore represent a measure of the speed at which the magnetizing object, such as a magnetic target, is moving. This makes it possible to simultaneously sense the position and the speed of the magnetizing object, such as a magnetic target.

According to another advantageous embodiment, an acceleration of the magnetizing object can be sensed when evaluating the respective electrical signals, such as the respective secondary voltages, at the third frequency, such as three times the frequency.

### LIST OF REFERENCE SYMBOLS

100 Speed sensor

101 Primary coil

103 First secondary coil

105 Second secondary coil

107 Goertzel filter bank

109 Processor

1. A speed sensor for sensing a speed of a magnetizing object, the speed sensor being able to be supplied with an electrical alternating signal at a first frequency by an electrical signal source, comprising:
a primary coil for generating an alternating magnetic field at the first frequency;
a first secondary coil and a second secondary coil, the first secondary coil and the second secondary coil each being able to be magnetically coupled to the primary coil by a magnetizable object, and a first electrical signal being able to be induced in the first secondary coil and a second electrical signal being able to be induced in the second secondary coil by the alternating magnetic field which is generated;
a Goertzel filter bank for recording a first amplitude value of a spectral component of the induced first electrical signal and a second amplitude value of a spectral component of the induced second electrical signal at a second frequency which differs from the first frequency; and
a processor for determining the speed of the magnetizing object on the basis of the recorded first amplitude value and the recorded second amplitude value.

2. The speed sensor as claimed in claim 1, the recorded respective amplitude value being a voltage value or a current value of the respective electrical signal.

3. The speed sensor as claimed in claim 1, the processor being designed to determine a difference between the recorded respective amplitude values in order to determine the speed of the magnetizing object.

4. The speed sensor as claimed in claim 1, the processor being designed to determine a Fourier coefficient on the basis of the recorded respective amplitude values in order to determine the speed of the magnetizing object.

5. The speed sensor as claimed in claim 1, having a memory in which calibration data are prestored, the processor being designed to determine the speed of the magnetizing object on the basis of the recorded respective amplitude values and the calibration data.

6. The speed sensor as claimed in claim 5, the calibration data being prestored in the memory in the form of a look-up table.

7. The speed sensor as claimed in claim 6, the processor also being designed to determine a difference between the recorded respective amplitude values, and a difference between the recorded respective amplitude values being assigned to a speed of the magnetizing object in the look-up table.

8. The speed sensor as claimed in claim 1, further comprising an analog/digital converter being connected upstream of the Goertzel filter bank.

9. The speed sensor as claimed in claim 1, further comprising a window device for signal windowing being connected upstream of the Goertzel filter bank.

10. The speed sensor as claimed in claim 1, the Goertzel filter bank comprising a further electrical signal source for generating a reference signal at the second frequency.

11. The speed sensor as claimed in claim 1, the second frequency being twice the first frequency, and the Goertzel filter bank comprising a frequency doubler for generating a reference signal at the second frequency.

12. The speed sensor as claimed in claim 1, the Goertzel filter bank comprising a first Goertzel filter for recording the first amplitude value and a second Goertzel filter for recording the second amplitude value.

13. The speed sensor as claimed in claim 1, the first frequency being in the range between 5 kHz and 20 kHz.

14. The speed sensor as claimed in claim 1, further comprising having-a further Goertzel filter bank for recording a further amplitude value of a further spectral component of the induced first electrical signal or of the induced second electrical signal at the first frequency, the processor also being designed to determine a position of the magnetizing object on the basis of the recorded further amplitude value.

15. The speed sensor as claimed in claim 1, further comprising a further Goertzel filter bank for recording a further amplitude value of a further spectral component of the induced first electrical signal or of the induced second electrical signal at a third frequency which differs from the first frequency and from the second frequency, the processor also being designed to determine an acceleration of the magnetizing object on the basis of the recorded further amplitude value.

16. The speed sensor as claimed in claim 2, the processor being designed to determine a difference between the recorded respective amplitude values in order to determine the speed of the magnetizing object.
